(19) United States
(12) Patent Application Publication
(10) Pub. No.: US 2026/0351760 A1
(43) Pub. Date: Nov. 5, 2026

(54) PROTECTIVE PLATE, HOUSING, AND BATTERY PACK

(71) Applicant: SVOLT ENERGY TECHNOLOGY CO., LTD., Changzhou (CN)

(72) Inventors: Jianwei BAI, Changzhou (CN); Fei REN, Changzhou (CN)

(73) Assignee: SVOLT ENERGY TECHNOLOGY CO., LTD., Changzhou (CN)

(21) Appl. No.: 19/487,485

(22) PCT Filed: May 27, 2024
(86) PCT No.: PCT/CN2024/095596

§ 371 Date: Nov. 25, 2025

(30) Foreign Application Priority Data
May 26, 2023 (CN) 202321312010.X

(51) Int. Cl. H01M 50/242; H01M 50/209; H01M 50/24; H01M 50/342; H01M 50/358

(52) U.S. Cl. CPC H01M 50/242; H01M 50/209; H01M 50/24; H01M 50/3425; H01M 50/358

(57) ABSTRACT

A protective plate, a housing, and a battery pack. A main body of the protective plate is provided with a plurality of exhaust parts and a plurality of connecting parts, and the plurality of exhaust parts and the plurality of connecting parts are sequentially and alternately arranged in a first direction; each of the exhaust parts is formed into a concave structure passing through opposite end parts of the main body in a second direction, and each of the connecting parts is provided with cavities passing through the opposite end parts of the main body in the second direction; when the main body is connected to a battery cell module, the connecting parts are bonded to the battery cell module, and the openings of the exhaust parts face explosion-proof valves of the battery cell module.

### CROSS REFERENCE TO THE RELATED APPLICATIONS

This application is the national phase entry of International Application No. PCT/CN2024/095596, filed on May 27, 2024, which is based upon and claims priority to Chinese Patent Application No. 202321312010.X, filed on May 26, 2023, the entire contents of which are incorporated herein by reference.

### TECHNICAL FIELD

The present disclosure relates to the field of battery pack protective structures, and specifically to a protective plate, a housing, and a battery pack.

### BACKGROUND

At present, the blade-type square battery cells have become main battery cells used in power batteries due to their characteristics such as high safety, high energy density, low cost, and thermal stability. The explosion-proof valve of the common blade-type cell is arranged on the side of the battery cell (as shown in FIG. 1). That is, in this form of battery cell, a certain amount of deformation is allowed at the bottom. Therefore, the prior bottom protection solution for the battery cell is to provide an MPP material member and a flat metal bottom protective plate at the bottom of the battery cell module (as shown in FIG. 2). However, as the demand for the thermal safety performance of battery power cells increases, the market share of blade-type battery cells with the explosion-proof valve placed at the bottom (as shown in FIG. 3) is gradually increased. If the existing battery cell bottom protection solution is still used, the metal bottom protective plate may compress the explosion-proof valve. The explosion-proof valve is relatively fragile, and even a slight compression deformation will cause problems such as cracking, liquid leakage, and insulation failure. Further, the prior metal bottom protective plate does not have corresponding exhaust channels, so that it cannot effectively guide the thermal runaway airflow (i.e., the high-pressure gas discharged by the explosion-proof valve). In addition, the prior metal bottom protective plate is connected to the battery cell module by the bolt and sealing gasket, and it is easy to cause sealing failure if a ball strike happens at the bottom. That is to say, the prior battery cell bottom protection solution is no longer applicable to the blade-type battery cell with the explosion-proof valve placed at the bottom.

### SUMMARY

In view of this, an objective of the present disclosure is to provide a protective plate, a housing, and a battery pack to solve the problem that the prior battery cell bottom protection solution is not applicable to the blade-type battery cell with the explosion-proof valve placed at the bottom.

In order to realize the above object, the technical solutions adopted in the embodiments of the present disclosure are as follows.

In a first aspect of the present disclosure, provided is a protective plate formed with a main body, wherein the main body is provided with a plurality of exhaust parts and a plurality of connecting parts, and the plurality of the exhaust parts and the plurality of the connecting parts are arranged at intervals sequentially in a first direction; the exhaust parts are provided with a concave structure passing through opposite end parts of the main body in a second direction, and the connecting parts are provided with cavities passing through the opposite end parts of the main body in the second direction; when the main body is connected to the battery cell module, the connecting parts are bonded to the battery cell module, and the openings of the exhaust parts face towards the explosion-proof valves of the battery cell module.

Further, the first direction is perpendicular to the second direction, and the second direction is the same as a direction of formation of the battery cell module when the main body is connected to the battery cell module.

Further, the two sidewalls of each exhaust part form bent structures that are symmetrical to each other, wherein each sidewall include a first inclined segment, a horizontal segment, and a second inclined segment which are connected in sequence; the first inclined segment is connected to bottoms of the exhaust parts; and the second inclined segment is connected to tops of the connecting parts.

Further, the horizontal segment is provided with a shielding member extending in the second direction, and the shielding member abuts against a bottom of the battery cell module when the main body is connected to the battery cell module.

Further, the high temperature resistant fireproof components are arranged inside the exhaust parts to form a high temperature resistant fireproof layer.

Further, tops of the connecting parts are bonded to bottoms of the battery cell module.

Further, the cavity has a thickness of 10 mm-15 mm.

Further, the main body is further provided with a reinforcement layer, and the reinforcement layer is located on one side of the main body away from the battery cell module when the main body is connected to the battery cell module.

In a second aspect of the present disclosure, a housing is provided, wherein a protective plate as described above is arranged at the bottom of the housing.

In a third aspect of the present disclosure, a battery pack is provided, wherein the battery pack is arranged with the housing as described above.

Compared with the prior art, the present disclosure includes the following beneficial effects. According to the protective plate, housing, and battery pack provided by the present disclosure, the plurality of exhaust parts are arranged at the top of the protective plate, and the openings of the exhaust parts can face towards the explosion-proof valves at the bottom of the battery cell module when the main body is connected to the battery cell module. The exhaust part passes through the opposite end part of the main body to form the exhaust channel corresponding to the explosion-proof valve, which can effectively guide the flow of high-pressure gas discharged by the explosion-proof valve, thereby preventing thermal runaway. Additionally, the explosion-proof valve is correspondingly arranged above the exhaust part which forms the concave structure, which can effectively prevent the main body from compressing the explosion-proof valve. In addition, the protective plate main body is bonded to the battery cell module by the connecting parts, wherein the connecting parts and the exhaust parts are arranged at intervals; and meanwhile, cavities are formed by the connecting parts. Compared with the existing connection method of bolts combined with sealing gaskets, the risk of failure is effectively reduced.

### BRIEF DESCRIPTION OF THE DRAWINGS

In order to more clearly illustrate the technical solutions in the embodiments of the present disclosure or in the prior art, the drawings to be used in the description of the embodiments or prior art will be briefly introduced below. It is obvious that the drawings in the following description are some embodiments of the present disclosure. For a person of ordinary skill in the art, other drawings can be obtained based on these drawings without inventive efforts.

FIG. 1 is a schematic diagram of a battery cell with the explosion-proof valve placed on the side in the prior art;

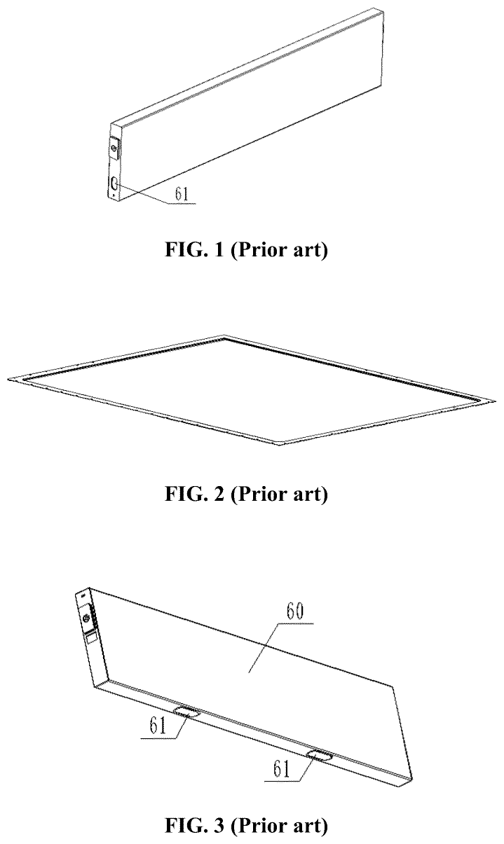

FIG. 2 shows a metal bottom protective plate in the prior art;

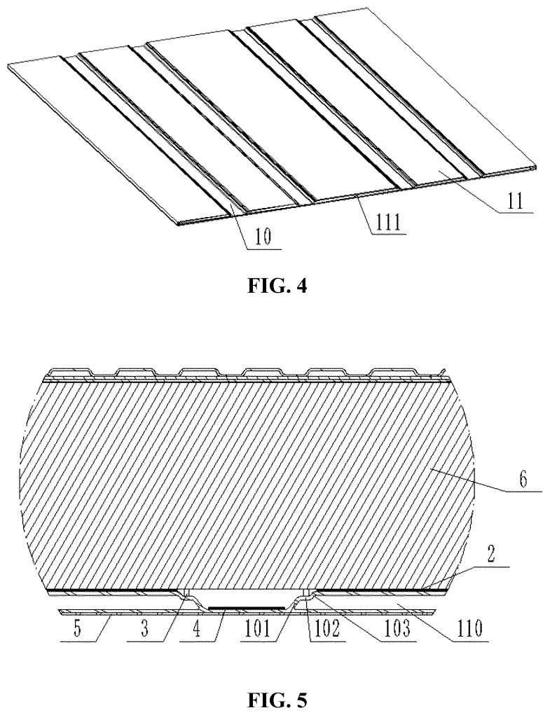

FIG. 3 is a schematic diagram of a battery cell with the explosion-proof valve placed on the bottom in the prior art;

FIG. 4 is a schematic diagram of a main body according to the embodiments of the present disclosure;

FIG. 5 is a partial sectional diagram of the connection between a protective plate and a battery cell module according to the embodiments of the present disclosure; and

FIG. 6 is a partial explosion schematic diagram of a battery pack according to the embodiments of the present disclosure.

Reference numbers: 1—main body; 10—exhaust part; 101—first inclined segment; 102—horizontal segment; 103—second inclined segment; 11—connecting part; 110—cavity; 111—reinforcement rib; 2—structural adhesive; 3—shielding member; 4—high temperature resistant fireproof layer; 5—reinforcement layer; 6—battery cell module; 60—battery cell; 61—explosion—proof valve; 7—side housing.

### DETAILED DESCRIPTION OF THE EMBODIMENTS

The technical solutions in the embodiments of the present disclosure will be clearly and completely described below in conjunction with the drawings in the embodiments of the present disclosure. It is obvious that the embodiments described are partial embodiments of the present disclosure, and not all of the embodiments.

The assembly in embodiments of the present disclosure generally described and shown in the drawings herein can be arranged and designed in various different configurations. Therefore, the following detailed description of the embodiments of the present disclosure arranged in the drawings is not intended to limit the scope of the present disclosure for which protection is claimed, but only represents selected embodiments of the present disclosure.

Based on the embodiments in the present disclosure, all other embodiments, obtained by a person of ordinary skill in the art without inventive efforts, shall all fall within the scope of protection of the present disclosure.

In the description of the present disclosure, it is to be noted that orientation or positional relationships indicated by terms, such as “center”, “up”, “down”, “left”, “right”, “vertical”, “horizontal”, “inside”, and “outside”, are the orientation or positional relationships based on the drawings, which are only to facilitate the description of the present disclosure and simplify the description, and are not to indicate or imply that the device or element referred to must have a particular orientation, or be constructed and operated with a particular orientation, and are not to be understood as limitations of the present disclosure. Additionally, the terms “first”, “second”, and “third”, etc., are used only for descriptions, and are not to be understood as indicating or implying a relative importance.

In the description of the present disclosure, it should be noted that unless other expressly specifications and limitations, the terms “mount”, “connect”, and “link” are to be understood in a broad sense, e.g. it can be a fixed connection, a detachable connection, or an integral connection; it can be a mechanical connection or an electrical connection; and it can be a direct connection, an indirect connection through an intermediate medium, or a communication inside two components. For a person of ordinary skill in the art, the specific meaning of the above terms in the present disclosure can be understood according to specific situations.

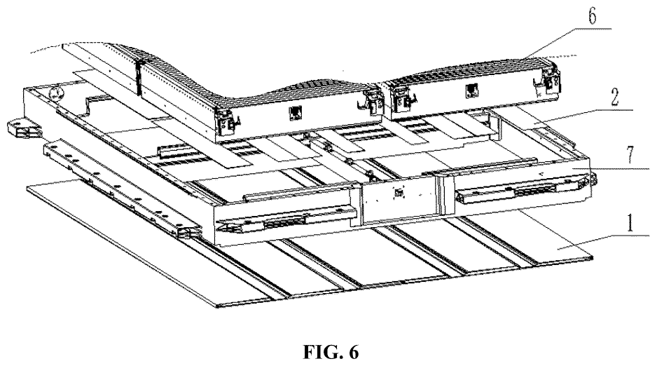

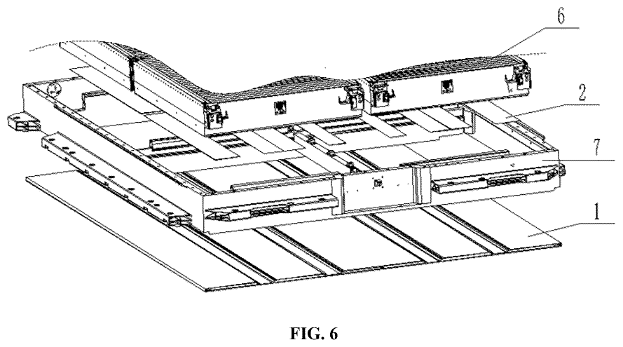

As shown in FIG. 3 to FIG. 6, a first aspect of the present disclosure provides a protective plate to protect the bottom of the battery cell 60 placed at the bottom of the explosion-proof valve 61. In the following text, the specific construction of the protective plate according to the present disclosure will be described in detail. In addition, it should be noted that stacking the plurality of battery cells 60 in sequence to form the battery cell module 6 is a conventional technical means in the field, and thus, it will not be repeated. Further, the stacking direction of the plurality of battery cells 60 is the formation direction of the battery cell module 6.

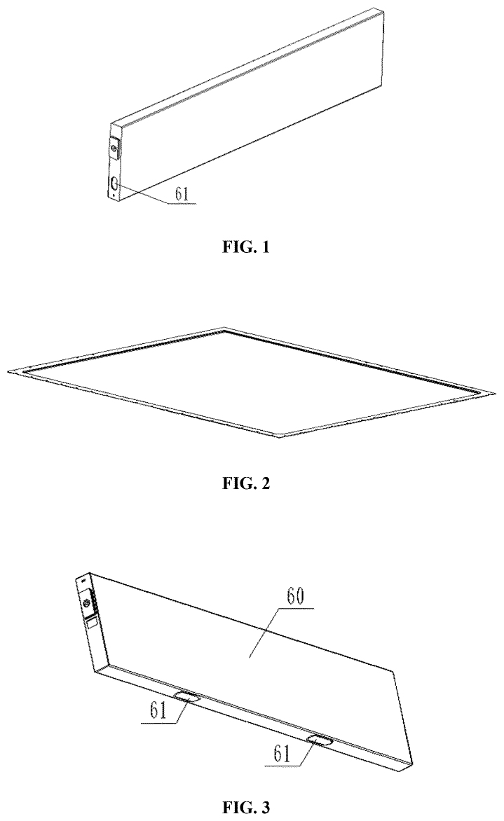

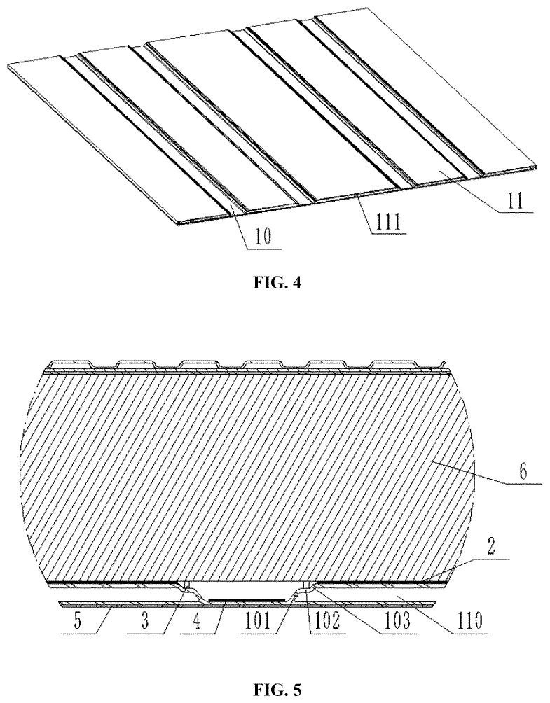

In the embodiment, as shown in FIG. 4 to FIG. 5, the protective plate forms a main body 1 of a rectangular plate-like structure. This structure can facilitate the assembly of components such as the main body 1 and the side housing 7, so as to form a housing for placing the battery cell module 6, and at the same time, this structure can also improve its stability when supporting the battery cell module 6. Specifically, a plurality of exhaust parts 10 and connecting parts 11 are formed on the top of the main body 1, and the plurality of exhaust parts 10 and the plurality of connecting parts 11 are arranged at intervals sequentially in the first direction (i.e., the width direction of the main body 1 in the embodiment). That is, the regions of the main body 1 other than the exhaust parts 10 are all formed into the connecting parts 11, and each of the connecting parts 11 is configured to bond to the bottom of the battery cell module 6. In this way, the large-area bonding between the main body 1 and the battery cell module 6 can be realized by the connecting parts 11, so as to improve the bearing capacity of the main body 1, and to reduce the risk of sealing failure caused by debonding of the main body 1 under various working conditions. In addition, by alternately arranging the connecting parts 11 and the exhaust parts 10, the stress borne by the main body 1 when supporting the battery cell module 6 can be distributed more evenly, thus effectively increasing the stability of the main body 1 and the battery cell module 6 when they are connected.

More specifically, in the embodiment, the tops of the connecting parts 11 are bonded to the bottoms of the battery cell module 6 by the structural adhesive 2, which can effectively prevent the deformation of cyclic expansion of the battery cell module 6. Meanwhile, it can reduce the risk of cracking of the structural member (such as the housing) caused by the expansion force, so as to improve the service life of the battery pack.

In addition, in the embodiment, as shown in FIG. 4 to FIG. 5, the connecting parts 11 are provided with cavities 110 passing through the opposite end parts of the main body 1 in the second direction (i.e., the length direction of the main body 1). That is, the connecting parts 11 are formed into double-layer structures. The gas such as air or the cushioning member such as a cushioning foam can be filled in the cavities 110 to form a cushioning part of the protective plate that resists impact, so as to further increase the stability of the structure of the main body 1 itself and of the connection between the main body 1 and the battery cell module 6. This can avoid the occurrence of sealing failure caused by ball impact on the bottom of the protective plate, so as to reduce the risk of the battery cell module 6 being invaded and deformed.

It is to be noted that the thickness of the cavity 110 is not specifically limited, and is preferably set at 10 mm to 15 mm. This dimensional range is the optimal choice to realize the above buffering effect to the greatest extent after many experiments. Further, when the width of the cavity 110 is too large, reinforcement ribs 111 can be arranged in the cavities 110, separating the cavities 110 into a plurality of sub-cavities. This ensures the load-bearing capacity of the main body 1. In addition, the above second direction is the same as a direction of formation of the battery cell module 6 when the main body 1 is connected to the battery cell module 6.

In the embodiment, as shown in FIG. 4 to FIG. 6, each of the exhaust parts 10 is provided with a concave structure passing through opposite end parts of the main body 1 in the second direction, and the opening of each exhaust part 10 (located at the top of the main body 1) faces towards the explosion-proof valve 61 at the bottom of the battery cell module 6 when the main body 1 is connected to the battery cell module 6. In this way, the exhaust part can form the exhaust channel corresponding to the explosion-proof valve 61, which can effectively guide the flow of high-pressure gas discharged by the explosion-proof valve 61, thereby preventing the thermal runaway. Additionally, the explosion-proof valve 61 is correspondingly arranged above the exhaust part 10 which forms the concave structure, thereby effectively preventing the main body 1 from compressing the explosion-proof valve 61. That is to say, in the embodiment, the exhaust part 10 not only provides an effective exhaust path for the explosion-proof valve 61, but also, on the basis of providing sufficient supporting stiffness for the main body 1, reserves a certain space for the explosion-proof valve 61, thereby reducing the risk of the explosion-proof valve 61 of the battery cell 60 being crushed and damaged.

Further, as shown in FIG. 5, the two sidewalls of each exhaust part 10 in the embodiment form bent structures that are symmetrical to each other. This arrangement can reduce the force on the battery cell 60 when the explosion-proof valve 61 is subjected to an impact from bottom. Specifically, the sidewalls of the exhaust parts 10 include a first inclined segment 101, a horizontal segment 102, and a second inclined segment 103 which are connected in sequence; the first inclined segment 101 is connected to a bottom of the exhaust parts 10; and the second inclined segment 103 is connected to a top of the connecting parts 11. It should be noted that the specific dimensions of the exhaust parts 10, such as its depth and the inclination of its sidewalls, are not specifically limited, provided that it corresponds to the explosion-proof valve 61 of the battery cell module 6 to achieve the aforementioned technical effect.

More specifically, the horizontal segment 102 of the sidewall of each exhaust part 10 is provided with a strip-shaped shielding member 3 extending in the second direction, and the shielding member 3 abuts against a bottom of the battery cell module 6 when the main body 1 is connected to the battery cell module 6. In the embodiment, the shielding member 3 is made of MPP material (i.e., a polypropylene porous foam material with a bubble hole size of less than 100 μm). Therefore, the shielding member 3 can improve the cushioning performance of the bending structure, and can further prevent the structural adhesive 2 at the top of the connecting parts 11 from overflowing into the exhaust parts 10. In addition, a high temperature resistant fireproof component (such as flame-retardant foam) is arranged on the bottom of each exhaust part 10 to form a high temperature resistant fireproof layer 4. Therefore, it can reduce the risk of the high-pressure gases discharged from the explosion-proof valve 61 burning through the protective plate when the battery cell module 6 undergoes the thermal runaway, and at the same time, the high temperature resistant fireproof layer 4 can further provide a certain insulating and protective effect. However, it is not limited to this, and the sidewalls of the exhaust parts 10 can be provided with the above high temperature resistant fireproof component.

Additionally, in the embodiment, the main body 1 of the protective plate is further provided with a reinforcement layer 5, and the reinforcement layer 5 is located on the bottom of the main body 1 away from the battery cell module 6 when the main body 1 is connected to the battery cell module 6. Further, the reinforcement layer 5 in the embodiment is formed by a PP glass fiber composite material (which is a prior material), so that the reinforcement layer 5 can enhance the overall stiffness of the main body 1 to a certain extent. It can further increase the ability of the main body 1 to resist impact, puncture, scratch, and abrasion, and it can also effectively improve the heat preservation performance of the following housing.

According to the protective plate of the present disclosure, the plurality of exhaust parts 10 are arranged at the top of the protective plate, and the openings of the exhaust parts 10 can face towards the explosion-proof valves 61 at the bottom of the battery cell module 6 when the main body 1 is connected to the battery cell module 6. The exhaust parts 10 pass through the opposite end parts of the main body 1 to form the exhaust channel corresponding to the explosion-proof valve 61, which can effectively guide the flow of high-pressure gas discharged by the explosion-proof valve 61, thereby preventing the thermal runaway. Additionally, the explosion-proof valve 61 is correspondingly arranged above the exhaust parts 10 which form the concave structures, which can effectively prevent the main body 1 from compressing the explosion-proof valve 61. In addition, the protective plate main body 1 is bonded to the battery cell module 6 by the connecting parts 11, wherein the connecting parts 11 and the exhaust parts 10 are arranged at intervals; and meanwhile, cavities 110 are formed by the connecting parts 11. Compared with the existing connection method of bolts combined with sealing gaskets, the risk of failure is effectively reduced.

In addition, according to a housing provided by the second aspect of the present disclosure, the protective plate as described above is arranged at the bottom of the housing.

In addition, according to a battery pack provided by a third aspect of the present disclosure, the battery pack is provided with the housing as described above.

Finally, it should be noted that the above-described embodiments are only intended to illustrate the technical solutions of the present disclosure, and are not intended to limit the present disclosure. Although the present disclosure has been described in detail with reference to the above embodiments, those skilled in the art should understand that modifications can still be made to the technical solutions described in the above embodiments, or some or all of the technical features may be equivalently replaced; such modifications or replacements do not cause the essence of the corresponding technical solutions to depart from the scope of the technical solutions of the embodiments of the present disclosure.

### Industrial Applicability

The present disclosure provides a protective plate, a housing, and a battery pack, wherein the opening of each exhaust part can face towards the explosion-proof valve at the bottom of the battery cell module when the main body is connected to the battery cell module. The exhaust parts pass through the opposite end part of the main body to form the exhaust channel corresponding to the explosion-proof valve, which can effectively guide the flow of high-pressure gas discharged by the explosion-proof valve, thereby preventing thermal runaway. Additionally, the explosion-proof valve is correspondingly arranged above the exhaust parts which form the concave structures, thus effectively preventing the main body from compressing the explosion-proof valve. In addition, the protective plate main body is bonded to the battery cell module by the connecting parts, the connecting parts and the exhaust parts are arranged at intervals, and meanwhile, cavities are formed by the connecting parts, thereby reducing the risk of failure.

What is claimed is:

1. A protective plate, provided with a main body, wherein the main body is provided with a plurality of exhaust parts and a plurality of connecting parts, and the plurality of the exhaust parts and the plurality of the connecting parts are arranged at intervals sequentially in a first direction; each of the plurality of exhaust parts is provided with a concave structure passing through opposite end parts of the main body in a second direction, and the plurality of connecting parts are provided with cavities passing through the opposite end parts of the main body in the second direction; and when the main body is connected to a battery cell module, the plurality of connecting parts are bonded to the battery cell module, and openings of the plurality of exhaust parts face towards explosion-proof valves of the battery cell module.

2. The protective plate according to claim 1, wherein the first direction is perpendicular to the second direction, and the second direction is the same as a direction of formation of the battery cell module when the main body is connected to the battery cell module.

3. The protective plate according to claim 1, wherein two sidewalls of each of the plurality of exhaust parts form bent structures that are symmetrical to each other; the two sidewalls comprise a first inclined segment, a horizontal segment, and a second inclined segment; the first inclined segment, the horizontal segment, and the second inclined segment are connected in sequence; the first inclined segment is connected to bottoms of the plurality of exhaust parts; and the second inclined segment is connected to tops of the plurality of connecting parts.

4. The protective plate according to claim 3, wherein the horizontal segment is provided with a shielding member extending in the second direction, and the shielding member abuts against a bottom of the battery cell module when the main body is connected to the battery cell module.

5. The protective plate according to claim 3, wherein high temperature resistant fireproof components are arranged inside the plurality of exhaust parts to form a high temperature resistant fireproof layer.

6. The protective plate according to claim 1, wherein tops of the plurality of connecting parts are bonded to bottoms of the battery cell module.

7. The protective plate according to claim 1, wherein each of the cavities has a thickness of 10 mm-15 mm.

8. The protective plate according to claim 1, wherein the main body is further provided with a reinforcement layer, and the reinforcement layer is located on one a side of the main body back away from the battery cell module when the main body is connected to the battery cell module.

9. A housing, wherein a bottom of the housing is provided with the protective plate according to claim 1.

10. A battery pack, wherein the battery pack is provided with the housing according to claim 9.
